(19) United States
(12) Patent Application Publication
(10) Pub. No.: US 2021/0116660 A1
(43) Pub. Date: Apr. 22, 2021

(54) SINGLE JACKET REDUCED DIAMETER RUGGEDIZED FIBER OPTIC DISTRIBUTION CABLES

(71) Applicant: AFL Telecommunications LLC, Duncan, SC (US)

(72) Inventors: Rajesh Kamath, Kent, WA (US); Brett Villiger, Simpsonville, SC (US); Michael Houck, Greenville, SC (US)

(21) Appl. No.: 16/494,036

(22) PCT Filed: Mar. 31, 2017
(86) PCT No.: PCT/US2017/025275

§ 371 Date: Sep. 13, 2019

(51) Int. Cl. G02B 6/44

(52) U.S. Cl. CPC G02B 6/4432

(57) ABSTRACT

A fiber optic distribution cable includes a jacket formed from one of a polyvinyl chloride or a low smoke zero halogen material. The jacket includes an outer surface and an inner surface, wherein the outer surface is an exterior surface of the cable and the inner surface defines an interior space of the cable. The fiber optic distribution cable further includes a plurality of optical fibers disposed within the interior space, and a plurality of strength members disposed within the interior space. A fiber density of the cable is greater than 1.3 fibers per square millimeter.

### FIELD OF THE INVENTION

The present disclosure relates generally to fiber optic distribution cables, and more particularly to fiber optic distribution cables having increased fiber densities and reduced associated diameters.

### BACKGROUND OF THE INVENTION

Optical fiber distribution cables are utilized in building/campus local area networks, central offices, data centers and other premises where high bandwidth data transfer is required. These cables can be deployed in both overhead and raised floor cable pathways, along with terminations into data cabinets. As data transfer requirements have increased, the number of fibers to support these demands has driven the development of high fiber density products. High density micro-cabling along with multi-fiber connectivity have been instrumental in supporting the increasing demands for high bandwidth data transfer.

Known distribution cables are typically sub-unitized and include a central strength member. However, while many such distribution cables are useful and provide the desired performance characteristics, improvements in distribution cable design are desired. For example, increased flexibility and fiber density are desired to provide improved installation and optical transmission capabilities. However, the ruggedness and relatively small overall size of the cables must desirably be maintained.

Accordingly, improved fiber optic distribution cables are desired in the art.

### BRIEF DESCRIPTION OF THE INVENTION

Aspects and advantages of the invention will be set forth in part in the following description, or may be obvious from the description, or may be learned through practice of the invention.

In accordance with one embodiment, a fiber optic distribution cable is provided. The fiber optic distribution cable includes a jacket formed from one of a polyvinyl chloride or a low smoke zero halogen material. The jacket includes an outer surface and an inner surface, wherein the outer surface is an exterior surface of the cable and the inner surface defines an interior space of the cable. The fiber optic distribution cable further includes a plurality of optical fibers disposed within the interior space, and a plurality of strength members disposed within the interior space. A fiber density of the cable is greater than 1.3 fibers per square millimeter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional view of a fiber optic distribution cable in accordance with embodiments of the present disclosure;

FIG. 2 is a top view of a plurality of optical fibers utilized in a fiber optic distribution cable in accordance with some embodiments of the present disclosure; and

FIG. 3 is a top view of a plurality of optical fibers utilized in a fiber optic distribution cable in accordance with other embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

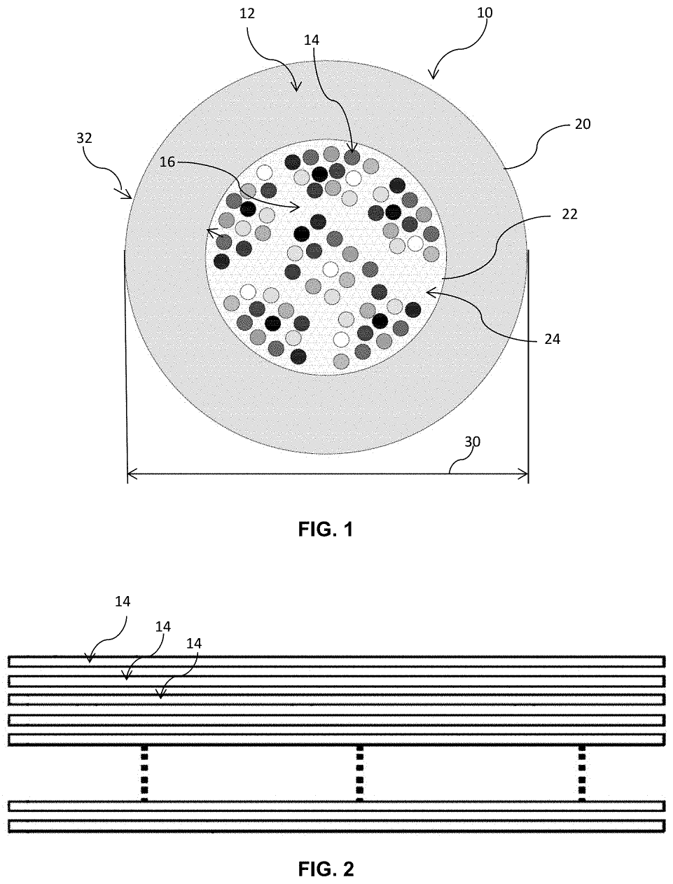

Referring now to FIG. 1, a fiber optic distribution cable 10 in accordance with embodiments of the present disclosure is provided. Cable 10 includes a jacket 12, and a plurality of optical fibers 14 disposed within the jacket 12. Additionally, a plurality of strength members 16 may be disposed within the jacket 12.

The jacket 12 is, as shown, the single, only layer forming the cable 10. No additional jackets, tubes, pipes, etc. are utilized in cables 10 in accordance with the present disclosure. The jacket 12 has a generally continuous tubular cross-sectional shape, as shown. Further, jacket 12 includes an outer surface 20 and an inner surface 22. The outer surface 20 is an exterior surface of the cable 10, and is thus the outermost surface 20 of the cable 10. The inner surface 22 defines an interior space 24 of the cable 10, which is generally a central interior space. The interior space 24 is an innermost open space of the cable 10, and the inner surface 22 directly defines the outer periphery of the interior space.

The jacket 12 is a single unit, and thus no sub-units are provided within the jacket 12. Rather, as shown, all optical fibers 14 utilized in cable 10 are disposed within jacket 12 and thus within interior space 24.

The jacket 12 may be formed from one of a polyvinyl chloride or a low smoke zero halogen material. In some embodiments, for example, the jacket 12 may be formed from a polyvinyl chloride. In exemplary embodiments, the jacket 12, and thus the material utilized to form the jacket 12, may be riser-rated or plenum-rated. For example, the jacket 12 and material thereof may have a flame rating of OFNR-LS/FT4 (riser-rated) (with, for example, a flame propagation characteristic of less than 12 feet) or OFNP/FT6 (plenum-rated) (with, for example, a flame propagation characteristic of less than 5 feet). In alternative embodiments, the jacket 12 may be formed from a low smoke zero halogen material, which may for example, include a polyolefin such as polyethylene. In exemplary embodiments, the jacket 12 and material thereof may have a flame rating of OFNR-LS/FT4 (with, for example, a flame propagation characteristic of less than 12 feet).

As discussed, strength members 16 may be disposed within the jacket 12, and thus within the interior space 24. In exemplary embodiments, the strength members 16 may be fibers, such as aramid fibers or other suitable fibers utilized for strength purposes. It should be noted that, in exemplary embodiments as shown, no additional components or materials, aside from strength members 16, optical fibers 14, and optional binders or ripcords, may be provided in interior space 24. Such space may thus, for example, be free from gels, additional intervening jackets or other tubes, pipes, etc.

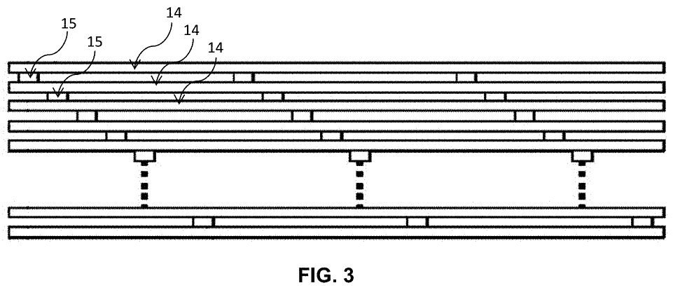

Any suitable optical fibers 14 may be utilized in cable 10. For example, the optical fibers 16 may be single mode optical fibers or multi-mode optical fibers. Further, in some embodiments, the optical fibers 14 may have nominal (plus or minus 3 microns) outer diameters of 250 microns. In alternative embodiments, the optical fibers 14 may have nominal outer diameters of 200 microns. In some embodiments, as illustrated in FIG. 2, the optical fibers 14 may be loose optical fibers which are not ribbonized or otherwise bonded to each other. In alternative embodiments, the optical fibers 14 may be ribbonized to form one or more ribbons. For example, in some embodiments as illustrated in FIG. 3, the optical fibers 14 may be intermittently bonded to each other (via, for example, portions of the outermost jacket or layer of the optical fibers 14), thus forming one or more ribbons. Such intermittent bonding may occur along the lengths of the optical fibers 14, thus leaving non-bonded gaps between neighboring optical fibers 14 as shown. Further, the bonded portions 15 of neighboring optical fibers 14 may be staggered along the lengths of the optical fibers 14 such that neighboring optical fibers 14 in a ribbon are bonded to each other at different locations along their lengths and the length of the ribbon.

Referring again to FIG. 1, cables 10 in accordance with the present disclosure may advantageously have relatively high fiber densities. As utilized herein, fiber density is the total number of optical fibers in a cable 10 divided by the cross-sectional area of the cable 10. The cross-sectional area may be calculated as pi times the square root of the maximum radius of the cable 10, and the maximum radius may be half of the maximum outer diameter 30 of the jacket 12. Further, cables 10 in accordance with the present disclosure may have such relatively high fiber densities while advantageously meeting the OFNR-LS/FT4, OFNP/FT6, and/or OFNR-LS/FT4 requirements. Meeting such requirements may require that a wall thicknesses 32 of jacket 12 is relatively high for a relatively low maximum outer diameter 30 of the jacket 12, thus further illustrating the advantageously high fiber densities achieved in accordance with the present disclosure. For example, as discussed herein and depending on the outer diameter 30, the jacket 12 may have a wall thickness 32 of between 0.95 and 2.05 millimeters, such as between 0.95 and 1.55 millimeters.

In some embodiments, the maximum outer diameter 30 may be less than or equal to 5 millimeters, such as less than or equal to 4.9 millimeters, such as between 4.9 millimeters and 4.7 millimeters, such as 4.8 millimeters. In these embodiments and when 250 nominal diameter micron optical fibers 14 are utilized, the fiber density may be between 1.3 and 1.35 fibers per square millimeter, such as between 1.31 and 1.34 fibers per square millimeter. Such embodiments may, for example, utilize between 12 and 24 optical fibers 14, such between 16 and 24 optical fibers, such as in some embodiments 12, 16, or 24 optical fibers 14.

Further, in these embodiments, the jacket 12 may have a wall thickness 32 of between 0.95 and 1.05 millimeters, such as 1.0 millimeters.

In other embodiments, the maximum outer diameter 30 may be less than or equal to 5.7 millimeters, such as less than or equal to 5.6 millimeters, such as between 5.6 millimeters and 5.4 millimeters, such as 5.5 millimeters. In these embodiments and when 250 nominal diameter micron optical fibers 14 are utilized, the fiber density may be between 1.5 and 1.55 fibers per square millimeter, such as between 1.51 and 1.54 fibers per square millimeter. Such embodiments may, for example, utilize between 25 and 36 optical fibers 14, such between 30 and 36 optical fibers, such as in some embodiments 36 optical fibers 14.

Further, in these embodiments, the jacket 12 may have a wall thickness 32 of between 1.05 and 1.15 millimeters, such as 1.1 millimeters.

In some embodiments, the maximum outer diameter 30 may be less than or equal to 6.7 millimeters, such as less than or equal to 6.6 millimeters, such as between 6.6 millimeters and 6.4 millimeters, such as 6.5 millimeters. In these embodiments and when 250 nominal diameter micron optical fibers 14 are utilized, the fiber density may be between 2.15 and 2.2 fibers per square millimeter, such as between 2.16 and 2.19 fibers per square millimeter. Such embodiments may, for example, utilize between 37 and 72 optical fibers 14, such between 48 and 72 optical fibers, such as between 64 and 72 optical fibers, such as in some embodiments 72 optical fibers 14.

Further, in these embodiments, the jacket 12 may have a wall thickness 32 of between 1.25 and 1.35 millimeters, such as 1.3 millimeters.

In some embodiments, the maximum outer diameter 30 may be less than or equal to 9.7 millimeters, such as less than or equal to 9.6 millimeters, such as between 9.6 millimeters and 9.4 millimeters, such as 9.5 millimeters. In these embodiments and when 250 nominal diameter micron optical fibers 14 are utilized, the fiber density may be between 2.0 and 2.05 fibers per square millimeter, such as between 2.01 and 2.04 fibers per square millimeter. Such embodiments may, for example, utilize between 73 and 144 optical fibers 14, such between 108 and 144 optical fibers, such as between 124 and 144 optical fibers, such as in some embodiments 144 optical fibers 14.

Further, in these embodiments, the jacket 12 may have a wall thickness 32 of between 1.95 and 2.05 millimeters, such as 2.0 millimeters.

Table 1 below provides various dimensions for cables 10 in accordance with exemplary embodiments of the present disclosure:

TABLE 1
Cable Dimensions (250 micron optical fiber nominal diameter)

| # of Optical | | Jacket Wall | |
|---|---|---|---|
| Fibers | Jacket OD | Thickness | Fiber |
| (250 micron) | (mm) | (mm) | Density |
| 24 | 4.8 | 1 | 1.33 |
| 36 | 5.5 | 1.1 | 1.52 |
| 72 | 6.5 | 1.3 | 2.17 |
| 144 | 9.5 | 2 | 2.03 |

In some embodiments, the maximum outer diameter 30 may be less than or equal to 4.7 millimeters, such as less than or equal to 4.6 millimeters, such as between 4.6 millimeters and 4.4 millimeters, such as 4.5 millimeters. In these embodiments and when 200 nominal diameter micron optical fibers 14 are utilized, the fiber density may be between 1.5 and 2.3 fibers per square millimeter. Such embodiments may, for example, utilize between 12 and 36 optical fibers 14, such between 16 and 36 optical fibers, such as between 24 and 36 optical fibers, such as in some embodiments 12, 16, 24, or 36 optical fibers 14. For example, in embodiments wherein 24 optical fibers are utilized, the fiber density may be between 1.5 and 1.55 fibers per square millimeter, such as between 1.5 and 1.54 fibers per square millimeter, such as between 1.5 and 1.53 fibers per square millimeter. In embodiments wherein 36 optical fibers are utilized, the fiber density may be between 2.25 and 2.3 fibers per square millimeter, such as between 2.25 and 2.29 fibers per square millimeter, such as between 2.25 and 2.28 fibers per square millimeter.

Further, in these embodiments, the jacket 12 may have a wall thickness 32 of between 0.95 and 1.05 millimeters, such as 1.0 millimeters.

In some embodiments, the maximum outer diameter 30 may be less than or equal to 6 millimeters, such as less than or equal to 5.9 millimeters, such as between 5.9 millimeters and 5.7 millimeters, such as 5.8 millimeters. In these embodiments and when 200 nominal diameter micron optical fibers 14 are utilized, the fiber density may be between 2.7 and 2.75 fibers per square millimeter, such as between 2.71 and 2.74 fibers per square millimeter. Such embodiments may, for example, utilize between 37 and 72 optical fibers 14, such between 48 and 72 optical fibers, such as between 64 and 72 optical fibers, such as in some embodiments 72 optical fibers 14.

Further, in these embodiments, the jacket 12 may have a wall thickness 32 of between 1.15 and 1.25 millimeters, such as 1.2 millimeters.

In some embodiments, the maximum outer diameter 30 may be less than or equal to 7.7 millimeters, such as less than or equal to 7.6 millimeters, such as between 7.6 millimeters and 7.4 millimeters, such as 7.5 millimeters. In these embodiments and when 200 nominal diameter micron optical fibers 14 are utilized, the fiber density may be between 3.25 and 3.3 fibers per square millimeter, such as between 3.25 and 3.29 fibers per square millimeter, such as between 3.25 and 3.28 fibers per square millimeter. Such embodiments may, for example, utilize between 73 and 144 optical fibers 14, such between 108 and 144 optical fibers, such as between 124 and 144 optical fibers, such as in some embodiments 144 optical fibers 14.

Further, in these embodiments, the jacket 12 may have a wall thickness 32 of between 1.45 and 1.55 millimeters, such as 1.5 millimeters.

Table 2 below provides various dimensions for cables 10 in accordance with exemplary embodiments of the present disclosure:

TABLE 2
Cable Dimensions (200 micron optical fiber nominal diameter)

| # of Optical | | Jacket Wall | |
|---|---|---|---|
| Fibers | Jacket OD | Thickness | Fiber |
| (200 micron) | (mm) | (mm) | Density |
| 24 | 4.5 | 1 | 1.51 |
| 36 | 4.5 | 1 | 2.26 |
| 72 | 5.8 | 1.2 | 2.73 |
| 144 | 7.5 | 1.5 | 3.26 |

Cables 10 in accordance with the present disclosure may further advantageously meet various Telecordia GR-409 Core Horizontal Backbone standard (GR-409 Issue 2, November 2008) requirements. In particular, such cables 10 may meet the GR-409 requirements for outer jacket shrinkage, compressive strength, tensile strength, temperature cycling, low-high temperature bend, impact resistance, cable twist, and/or cyclic flexing. For example, in some embodiments, a cable 10 in accordance with the present disclosure may have a tensile strength of up to or at least 150 pounds. In some embodiments, a cable 10 in accordance with the present disclosure may exhibit an attenuation change of less than or equal to 0.03 dB, such as 0.025 dB when subjected to 4 bends around a 7 inch diameter mandrel and with a weight (which is 10 kg for cables having less than 6.5 millimeter jacket outer diameters and is 12.5 kg for cables having greater than or equal to 6.5 millimeter outer diameters) suspended at the end of the 4 wraps at −10, 0, or 70° C. In some embodiments, a cable 10 in accordance with the present disclosure may exhibit an attenuation change of less than or equal to 0.03 dB, such as 0.02 dB, when subjected to 25 cycles in a 180 degree arc (90 degrees clockwise and 90 degrees counterclockwise) with a 4 kg load attached to the end. In some embodiments, a cable 10 in accordance with the present disclosure may exhibit an attenuation change of less than or equal to 0.005 dB, such as 0.002 dB, when subjected to a minimum of 10 cycles of being twisted 180 degrees clockwise and counter-clockwise. In some embodiments, a cable 10 in accordance with the present disclosure may exhibit an attenuation change of less than or equal to 0.10 dB, such as less than or equal to 0.082 dB, when subjected to a compressive load of at least 100 N/cm over a period of 10 minutes, with the load applied at an increase of 3 to 20 mm per minute. In some embodiments, a cable 10 in accordance with the present disclosure may exhibit an attenuation change of less than or equal to 0.002 dB, such as less than or equal to 0.001 dB, when subjected to 2 impacts at 3 locations (which are 150 mm apart) of a drop force of 2.94 Nm from a height of 150 mm. In some embodiments, a cable 10 in accordance with the present disclosure may exhibit an attenuation change of less than or equal to 0.25 dB, such as less than or equal to 0.009 dB (single mode fiber) or less than or equal to 0.24 dB (multi-mode fiber) when subjected to extreme temperatures over 120 hours ranging from 0 C to 70 C (for plenum-rated cables) or −20 C to 70 C (for LSZH cables), including a rate of change of temperature of 40 degrees per hour and multiple exposure cycles at the extreme temperatures for 24 continuous hours within the 120 hours.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fiber optic distribution cable, comprising:
a jacket formed from one of a polyvinyl chloride or a low smoke zero halogen material, the jacket comprising an outer surface and an inner surface, wherein the outer surface is an exterior surface of the cable and the inner surface defines an interior space of the cable;
a plurality of optical fibers disposed within the interior space; and
a plurality of strength members disposed within the interior space;
wherein a fiber density of the cable is greater than 1.3 fibers per square millimeter.

2. The fiber optic distribution cable of claim 1, wherein the strength members are aramid fibers.

3. The fiber optic distribution cable of claim 1, wherein the jacket is formed from the polyvinyl chloride.

4. The fiber optic distribution cable of claim 3, wherein the jacket is one of riser-rated or plenum-rated.

5. The fiber optic distribution cable of claim 1, wherein the jacket is formed from the low smoke zero halogen material.

6. The fiber optic distribution cable of claim 5, wherein the low smoke zero halogen material comprises a polyolefin.

7. The fiber optic distribution cable of claim 1, wherein the plurality of optical fibers have nominal outer diameters of 250 microns.

8. The fiber optic distribution cable of claim 7, wherein the jacket has a maximum outer diameter of less than or equal to 5 millimeters and the fiber density is between 1.3 and 1.35 fibers per square millimeter.

9. The fiber optic distribution cable of claim 7, wherein the jacket has a maximum outer diameter of less than or equal to 5.7 millimeters and the fiber density is between 1.5 and 1.55 fibers per square millimeter.

10. The fiber optic distribution cable of claim 7, wherein the jacket has a maximum outer diameter of less than or equal to 6.7 millimeters and the fiber density is between 2.15 and 2.2 fibers per square millimeter.

11. The fiber optic distribution cable of claim 7, wherein the jacket has a maximum outer diameter of less than or equal to 9.7 millimeters and the fiber density is between 2.0 and 2.05 fibers per square millimeter.

12. The fiber optic distribution cable of claim 1, wherein the plurality of optical fibers have nominal outer diameters of 200 microns.

13. The fiber optic distribution cable of claim 12, wherein the jacket has a maximum outer diameter of less than or equal to 4.7 millimeters and the fiber density is between 1.5 and 2.3 fibers per square millimeter.

14. The fiber optic distribution cable of claim 12, wherein the jacket has a maximum outer diameter of less than or equal to 6 millimeters and the fiber density is between 2.7 and 2.75 fibers per square millimeter.

15. The fiber optic distribution cable of claim 12, wherein the jacket has a maximum outer diameter of less than or equal to 7.7 millimeters and the fiber density is between 3.25 and 3.3 fibers per square millimeter.

16. The fiber optic distribution cable of claim 1, wherein the jacket has a wall thickness of between 0.95 and 2.05 millimeters.

17. The fiber optic distribution cable of claim 1, wherein the jacket has a wall thickness of between 0.95 and 1.55 millimeters.

18. The fiber optic distribution cable of claim 1, wherein the optical fibers are loose optical fibers.

19. The fiber optic distribution cable of claim 1, wherein the optical fibers are intermittently bonded to each other.

20. The fiber optic distribution cable of claim 1, wherein the cable has a tensile strength of greater than or equal to 150 pounds.
